(19) United States
(12) Patent Application Publication
(10) Pub. No.: US 2026/0203349 A1
(43) Pub. Date: Jul. 16, 2026

(54) Method and system for populating a structured database

(71) Applicant: In Parallel Oy, Helsinki (FI)

(72) Inventors: Kristian Luoma, Helsinki (FI); Markku Mäkelainen, Helsinki (FI); Michal Olczak, Helsinki (FI); Hanna Kettunen, Helsinki (FI); Katariina Kari, Helsinki (FI); Sami Niemelä, Helsinki (FI)

(21) Appl. No.: 19/015,916

(22) Filed: Jan. 10, 2025

(51) Int. Cl. G06F 16/901; G06F 16/248; G06F 16/25; G06F 16/93

(52) U.S. Cl. CPC G06F 16/9024; G06F 16/248; G06F 16/258; G06F 16/93

(57) ABSTRACT

According to an example aspect of the present invention, there is provided method of populating a structured database, the method comprising providing, to a natural language parser, at least one computer-readable document, parsing, by the natural language parser, said at least one computer-readable document, wherein the parsing extracts at least one chunk of relevant content from the said at least one computer-readable document, providing the extracted at least one chunk of relevant content to a trained neural network model, the trained neural network model being trained on a predefined ontology, generating, by the trained neural network model, at least one structured object based at least in part on the extracted at least one chunk of relevant content, generating, by the trained neural network model, a complex decision graph, based at least in part on the ontology, said graph comprising at least one of the structured objects, wherein the generating comprises: optionally creating and/or modifying, by the trained neural network model, at least one additional structured decision object, and creating, by the trained neural network model, edges and weights between structured objects, converting the generated graph into vector format, and providing the converted graph in vector format to a structured database.

### FIELD

This disclosure provides a method and system for creating and modifying graph models based on computer-readable documents and a predefined ontology. Such graph models are useful, for example when handling large amounts of unstructured data, in particular in the field of business planning and/or strategy applications.

### BACKGROUND

Enterprise information may be conveyed in unstructured documents, such as emails. While plans and strategies should be formulated based on such information, it is difficult, in practice, to collect and organize said information in a structured manner.

### SUMMARY OF THE INVENTION

The invention is defined by the features of the independent claims. Some specific embodiments are defined in the dependent claims.

According to a first aspect of the present invention, there is provided a method of populating a structured database, the method comprising providing, to a natural language parser, at least one computer-readable document, parsing, by the natural language parser, said at least one computer-readable document, wherein the parsing extracts at least one chunk of relevant content from the said at least one computer-readable document, providing the extracted at least one chunk of relevant content to a trained neural network model, the trained neural network model being trained on a predefined ontology, generating, by the trained neural network model, at least one structured object based at least in part on the extracted at least one chunk of relevant content, generating, by the trained neural network model, a complex decision graph, based at least in part on the ontology, said graph comprising at least one of the structured objects, wherein the generating comprises: optionally creating and/or modifying, by the trained neural network model, at least one additional structured decision object, and creating, by the trained neural network model, edges and weights between structured objects, converting the generated graph into vector format, and providing the converted graph in vector format to a structured database.

According to a second aspect of the present invention, there is provided a system for populating a structured database, the system comprising an apparatus comprising a processing core, at least one memory including computer program code, the at least one memory and the computer program code being configured to, with the at least one processing core, cause the apparatus at least to: receive at least one chunk of content based on at least one computer-readable document, provide the at least one chunk of content to a trained neural network model, the trained neural network model being trained on a predefined ontology, generate, using the trained neural network model, at least one structured object based at least in part on the at least one chunk of content, generate, by the trained neural network model, a graph, said graph comprising at least one of the structured objects, wherein the generating comprises: optionally creating and/or modifying, by the trained neural network model, at least one additional structured object, and creating, by the trained neural network model, edges and weights between structured objects, convert the generated graph into vector format, and provide the converted graph in vector format to a structured database.

According to a third aspect of the present invention, there is provided a non-transitory computer readable medium having stored thereon a set of computer readable instructions that, when executed by at least one processor, cause an apparatus to at least perform the first aspect or the second aspect.

Various embodiments of the first, the second or the third aspect may comprise at least one feature from the following bulleted list:
wherein the structured objects comprise at least one of: a structured decision object, a structured execution object or a structured capability object,
wherein the structured database is configured to be searchable by the user, wherein the search is performed by the user interface device configured to vector search, for example nearest neighbor search, the structured database,
displaying, by the user interface device, the converted graph within the structured database or a portion thereof at a certain point of time, wherein for example, the user may adjust the displayed point of time,
wherein at least one alignment state agent corresponding to a structured object within the graph is configured to act as an agent for at least one structured decision object, wherein the agent may be configured, for example, to check the dependencies of said single structured decision object, and
wherein the method comprises performing a simulation, said performing comprising setting an outcome for at least one structured object and generating, using the trained machine learning model, a graph based on the set outcome.

### BRIEF DESCRIPTION OF THE DRAWINGS

FIG. 1 illustrates a schematic view of an example system in accordance with at least some embodiments of the present disclosure;

FIG. 2 illustrates a schematic view of an example process in accordance with at least some embodiments of the present disclosure;

FIG. 3 illustrates a schematic view of an example process in accordance with at least some embodiments of the present disclosure;

FIG. 4 illustrates a schematic view of an exemplary structured object in accordance with at least some embodiments of the present disclosure;

FIG. 5 illustrates a schematic view of an example hierarchy in accordance with at least some embodiments of the present disclosure;

FIG. 6 illustrates a schematic view of an example hierarchy in accordance with at least some embodiments of the present disclosure;

FIG. 7 illustrates a schematic view of an example process in accordance with at least some embodiments of the present disclosure;

FIG. 8 illustrates a schematic view of an example hierarchy in accordance with at least some embodiments of the present disclosure;

FIG. 9 illustrates a schematic view of an example system in accordance with at least some embodiments of the present disclosure; and

FIG. 10 illustrates a schematic view of an example process in accordance with at least some embodiments of the present disclosure.

### EMBODIMENTS

The present disclosure provides a method and system for creating and modifying graph models based on computer-readable documents and a predefined ontology. Such graph models are useful, for example when handling large amounts of unstructured data. A trained machine learning model, for example a neural network model, is used to generate the graph. The graph is then converted into vector format and stored in a structured database to “freeze” the graph. The graph may represent business tasks, for example an organizational strategy. A user interface may be used to allow a user to interact with the graph.

### Definitions

A computer-readable document refers to a digital representation of information, for example stored in a file format. Examples include at least one of: a video, an audio recording or transcription thereof, an email, a pdf file, a word processor file, a spreadsheet, or any office software suite file format, for example any Microsoft office file. The computer-readable document may be unstructured. An unstructured document is a document which does not conform to a pre-defined acceptable format, or which is presented in an alternative format than other documents. For example, a unstructured document may be a document which has not been parsed or converted according to the ontology discussed herein.

A computer-readable document may comprise a user survey. A computer readable document may comprise company information, for example one or more of: organizational structure, organization functions, time frames, vision, mission, financial information and/or any further company information. Computer-readable documents may be collected, or generated, for example via a UI performed by a web browser.

A natural language parser refers to a program or a program function, executable by a processor, said program configured to: receive natural language input, process said natural language input into output data, and provide said output data. The providing may be done, for example, to another program and/or a machine learning model. The providing may be done via an API and/or by saving the output data to a disk system.

Parsing, by the natural language parser, refers to recognizing relevant content in the entity being parsed, and then extracting the recognized relevant content. Recognition may comprise at least one of: syntax analysis, relationship extraction, semantic parsing, conference resolution, topic segmentation and recognition, for example. Extraction may comprise conveying the information in the text, in original or in converted form, to another program or system. The information may be represented in a structured manner, for example as a structured representation of a piece of text. For example, the information in a piece of text may be conveyed in a graph form, the graph form based on semantic parsing of said piece of text.

The natural language parser may be configured to recognize and extract at least one chunk of relevant content. Chunk of relevant content refers to information which is relates to a pre-selected domain of the user, for example business or sports. In the case of business, relevant content may be the words “market share” in a piece of text, wherein the chunk of relevant content may be the paragraph of text comprising said words. For example, if the piece of text is converted into graph form, the entities which are not relevant content may be removed from the graph before or after conveying. The natural language parser may be performed by the same device as the trained machine learning model, or by a different apparatus. For example, a lexicon comprising a plurality of terms may be used to identify the relevant content, wherein the parser may be configured to utilize synonyms of the terms as well. The lexicon may be based on the ontology.

Ontology refers to a framework usable to codify the relationships of entities to one another. The ontology comprises rules and categories, and a priori information of typical relationships between entities. The ontology may comprise a hierarchy of decisions, wherein the hierarchy comprises a plurality of decision categories, for example major decisions, minor decisions, and detail-level decisions. Predefined ontology refers to an ontology which has been determined in advance and used, for example, to train a machine learning model. The ontology may be stored on an electronic storage medium, said medium being accessible to a trained machine learning model, wherein the trained machine learning model may be configured to access and/or update said predefined ontology. For example, the trained machine learning model may alter the ontology based for example at least in part on obtained relevant content. The trained machine learning model may comprise the ontology.

A machine learning model refers to a computational framework designed to process input data and generate output predictions or decisions by learning patterns and relationships from training data, typically through the optimization of parameters. A machine learning model may be a neural network model. A neural network model refers to a neural network which may be, for example, a feed-forward neural network, a convolution neural network, or a recurrent neural network, or a graph neural network. A neural network may comprise a classifier and/or regression. The neural network model may be a convolutional neural network comprising multiple convolutional layers for feature extraction. The neural network may apply a supervised learning algorithm. In supervised learning, a sample of inputs with known outputs is used from which the network learns to generalize. Alternatively, the model may be constructed using an unsupervised learning or a reinforcement learning algorithm.

A trained neural network has been trained with training data to perform a specific task with a defined level of accuracy. The trained neural network may be a graph neural network. The weights and connections of the trained machine learning model may be stored on an electronic storage medium. The trained machine learning model may be configured, for example, to map the decisions, based at least in part on the decisions within the hierarchy, to structured objects in the graph. The trained machine learning model may be configured to remove at least one structured decision object from the generated graph, for example when a node without connections is removed. The trained machine learning model may be configured to classify the extracted chunks of content of relevance into at least two decision categories. The trained machine learning model may be configured to transform the computer-readable documents into a complex decision graph based at least in part on the ontology.

A decision graph is a structured model that represents a complex decision-making using interconnected decision units, each addressing specific sub-decisions. The decision graph comprises nodes and directed edges. In the graph, each node signifies a decision point, and the directed edges illustrate the dependencies and flow between these decisions.

Training data refers to the data used to train the trained machine learning model. Training data may comprise, for example, an ontology. Training data may comprise, for example, market data from a plurality of companies. Such market data may comprise at least one of: earnings call data, publicly available data such as SEC data, stock market data. Training data may be provided over a time span, for example from 1 to 30 years. Training data may be provided at a frequency from a month to a year. Additionally or alternatively, training data may comprise a snapshot of a previously trained model. Additionally or alternatively, training data may comprise cause and effect comparisons of public data.

Classification refers to a task, for example a machine learning task, in which input data is processed and assigned to one or more categories or classes, which may be predefined.

A graph refers to a data structure comprising a set of nodes (vertices) and edges (connections) that represent relationships, dependencies, or interactions between entities, wherein the graph may be generated as an output of a machine learning system based on the analysis of input data. The graph may be termed a complex decision graph. The nodes may correspond to entities or data points, and the edges may represent relationships, weights, or other properties inferred by the machine learning system. In particular, the graph may be a semantic graph, where edges describe semantic relations between the nodes. The graph may comprise multiple dependencies and/or connections between objects. The graph may comprise recursive objects. A recursive object refers to a node, or a subgraph, that is defined in terms of itself or its relationship to other similar elements within the graph, enabling iterative or hierarchical processing, such as traversals, aggregations, or structural computations. The graph may be stored on an electronic storage medium.

Vector format refers to a representation of a graph in which nodes and edges are encoded as numerical vectors or matrices. The nodes may be represented as individual vectors in a vector space. For example, the attributes or features of the nodes may be embedded. For example, edges may be represented as relationships or transformations between node vectors. Using vector format enables efficient storage, processing, and computation. Further, for example linear algebra techniques may be used.

A structured database refers to a database which may be implemented by a computer apparatus, for example by a server apparatus. The database may be implemented at least in part on a disk system of a computer apparatus. The database may comprise a vector database, vector store or a vector search engine. The database may be configured to store vectors, which may be fixed-length lists of numbers, and optionally other data types.

A structured object refers to an entity generated by a trained machine learning model. A structured object may be a structured decision object or a structured execution object. A structured object may be used as a node in the generated graph, for example as a node in a semantic network. A structured object may have at least one input, for example an edge linking the structured object to another object. A structured object may have at least one output, for example an edge linking the structured object to another object. A structured object may comprise data, for example any of the following: type of object, hierarchical level of object, metadata. The trained machine learning model may be configured to assign responsible entities to at least some of the structured objects.

Structured decision object refers to a structured object, for example generated by a trained machine learning model, based directly or indirectly and at least in part on relevant content, wherein the generation may be based at least in part on the predefined ontology. Typically, the structured decision object will represent a strategic decision by the organization. A structured decision object may be within any one of at least the following categories: a goal, a key performance indicator (KPI), a dependency. For example, a structured decision object may comprise increasing market share in a specified market.

Structured execution object refers to a structured object, for example generated by a trained machine learning model, based directly or indirectly and at least in part on relevant content, wherein the generation may be based at least in part on the predefined ontology. A structured execution object may comprise at least one capability requirement. Typically, the structured execution object will represent an initiative to be executed by the organization. For example, a structured execution object may comprise a task to be performed by the organization.

A capability object refers to a structured object which may be generated by a trained machine learning model based directly or indirectly and at least in part on relevant content, wherein the generation may be based at least in part on the predefined ontology. A structured capability object may comprise at least one capability attribute. For example, a capability attribute may be production capacity.

A means for communication refers to an interface between the structured database and a user, for example the means for communication may be a user interface apparatus. The means for communication may be performed by the same apparatus as the trained machine learning model, or by a different apparatus. Any such apparatus may comprise at least one processing core, at least one memory including computer program code, the at least one memory and the computer program code being configured to, with the at least one processing core, cause the apparatus at least to execute a browser application, said application configured to display content to the user.

The means for communication may be configured so that the user may interact with the structured database and the contents therein via the means for communication. The means for communication may be configured to display a portion of the converted graph within the structured database. The means for communication may be configured to display a portion of the converted graph within the structured database. The means for communication may be configured to display a user interface viewport, said viewport configured to display at least part of the graph, and a text field configured to accept user input.

A search query refers to a query which the user may input into the means for communication, whereby the means for communication is configured to answer the query. The query may be, for example, a text string query. The search query may comprise natural language. The search query may be a context query, represented as a numerical vector in a vector space. The context query may be used to retrieve, compare, or analyze data points or entities based on their contextual similarity or relevance within the same vector space. The context query may be used with the vector format graph, enabling operations such as nearest-neighbour searches or similarity-based ranking. Replies to user queries may be in textual and/or graphical format, for example a portion of the graph may be displayed with accompanying text.

Interacting, by a user, refers to any of the following: viewing, accessing, querying, modifying, and/or causing any of the following: to be viewed, accessed, queried, or modified.

A help monitor refers to a system, a subsystem or programmatic function which is configured to monitor the structured database, for example by performing automated checks. Such checks may be progress checks, for example. A help monitor may be configured to provide feedback data, wherein the feedback data comprises, for example, current progress confidence. Such feedback may be provided in the form of user interface alerts. The help monitor may be configured to suggest and or implement corrections relating to the content of the structured database. For example, the help monitor may be configured to determine if any nodes of the converted graph have fewer than 2 connections, for example fewer than 1 connection, and produce an alert comprising the node identifier.

ERP, enterprise resource planning, system refers to a software platform that integrates and manages core business processes, for example finance, supply chain, human resources, and manufacturing. An example is SAP.

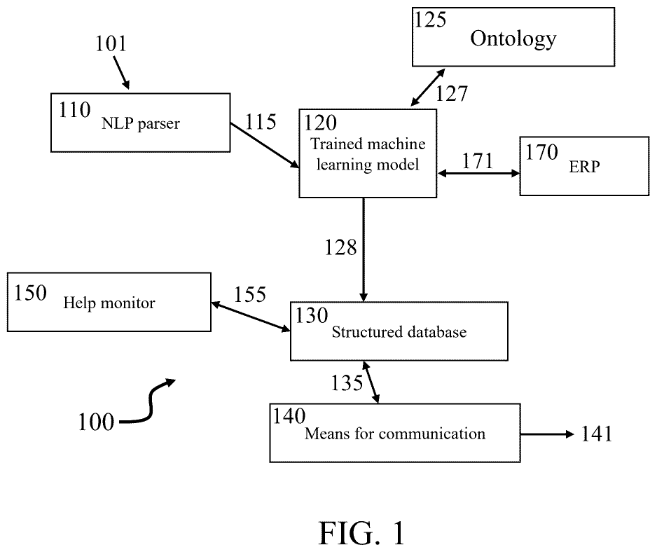

FIG. 1 illustrates an exemplary system 100 in accordance with at least some embodiments of the present disclosure.

As can be seen in the figure, exemplary system 100 comprises natural language parser 110, trained machine learning model 120, ontology 125, structured database 130 and a means for communication 140. Optionally, the system 100 may further comprise help monitor 150. Optionally, the system 100 may comprise or connect to ERP system 170.

System 100 may be implemented in an apparatus comprising: at least one processor core, at least one memory including computer program code, the at least one memory and the computer program code being configured to, with the at least one processing core, cause the apparatus at least to perform the population of the structured database as discussed herein. System 100 may comprise a single apparatus, or several apparatuses operating together to perform the population.

Natural language parser 110 is configured to obtain at least one computer readable document 101, which may be for example an unstructured document. Documents 101 may comprise, for example, several dozens, or hundreds, or even thousands of documents. The obtaining may be done in any suitable manner. Examples of obtaining may include one or more of the following: accessing a file, for example accessing a file on a disk; receiving an email; receiving a file via a web browser interface; or receiving a file via an API.

Natural language parser 110 is configured to parse the obtained document(s) 101. Parsing refers to recognizing relevant content, and then extracting the recognized relevant content. The recognized relevant content may be referred to, for example, as chunks of content of relevance.

Natural language parser 110 is configured to output the recognized relevant content 115. The outputting may be done, for example, to another program and/or a machine learning model. The outputting may be done via an API and/or by saving the output data to a disk system.

Trained machine learning model 120 may be a neural network which may be, for example, a feed-forward neural network, a convolution neural network, or a recurrent neural network, or a graph neural network. Trained machine learning model 120 may be trained using ontology 125.

Trained machine learning model 120 is configured to receive the relevant content 115 as an input. Trained machine learning model 120 is configured to generate, based at least in part on the relevant content 115, at least one structured object. Trained machine learning model 120 is configured to generate at least one graph, comprising at least one structured object. The graph generation may comprise creating additional structured objects and/or creating edges and weights between structured objects. Trained machine learning model 120 may be configured to generate the edges and weights between structured decision objects based at least in part on company data, for example organizational structure data, provided to the natural language parser and/or the trained neural network model.

Trained machine learning model 120 may be configured to autonomously create additional structured objects and the edges and weights thereof, based at least in part on the extracted at least one chunk of relevant content and at least in part on the graph structure. For example, the trained machine learning model may create downstream or upstream nodes for structured objects.

Trained machine learning model 120 is configured to convert the generated graph into vector format 128. Trained machine learning model 120 is configured to provide the vector format graph 126 to a structured database 130. Trained machine learning model 120 is configured to provide the vector format graph 126 to an electronic storage medium.

Structured database 130 may be implemented by a computer apparatus, for example by a server apparatus. The database may be implemented at least in part on a disk system of a computer apparatus. The database may comprise a vector database, vector store or a vector search engine. The database may be configured to store vectors, which may be fixed-length lists of numbers, and optionally other data types. Structured database 130 is configured to store vector format graph 126. Structured database 130 is configured to be accessible to means for communication 140 and trained machine learning model 120.

Ontology 125 may be stored on an electronic storage medium. Ontology 125 is configured to be accessible to trained machine learning model 120. Ontology 125 may comprise rules and categories. Ontology 125 may comprise a priori information of typical relationships between entities. Ontology 125 may comprise strategic frameworks. Ontology 125 may comprise a hierarchy of decisions, wherein the hierarchy comprises a plurality of decision categories, for example major decisions, minor decisions, and detail-level decisions. Ontology 125 may be predefined, whereby the ontology has been determined in advance and provided to machine learning model 120, or additionally or alternatively used to train machine learning model 120.

Means for communication 140 may be performed by the same apparatus as the trained machine learning model, or by a different apparatus. Any such apparatus may comprise at least one processing core, at least one memory including computer program code, the at least one memory and the computer program code being configured to, with the at least one processing core, cause the apparatus at least to execute a browser application, said application configured to display content to the user. The means for communication may be configured to display a portion of the converted graph within the structured database. The means for communication may be configured to display a user interface viewport, said viewport configured to display at least part of the graph, and a text field configured to accept user input.

The means for communication 140 may be configured so that the user may interact with the structured database and the contents therein via the means for communication. For example, the converted graph, stored in the structured database 130, may be accessible to a user, for example via a user interface device such as an apparatus comprising a web browser. In particular, the user may submit queries regarding the content of structured database 130 via means for communication 140. Replies to such queries may be in textual and/or graphical format, for example a portion of the graph may be displayed with accompanying text.

Help monitor 150 generates feedback regarding the generated graph. The help monitor may be configured to perform checks, for example sanity checks, with respect to the generated graph. Such checks may be progress checks, for example. Help monitor 150 may be configured to provide feedback data, wherein the feedback data comprises, for example, current progress confidence. Such checks may be initiated automatically, for example after generating a graph, or manually by a user via the UI.

ERP system 170 may be performed by an apparatus comprising at least one processing core, at least one memory including computer program code, the at least one memory and the computer program code being configured to, with the at least one processing core, cause the apparatus at least to execute an ERP application, said application configured to display content to the user. ERP system 170 may comprise or connect to a database comprising business data.

The trained machine learning model of this disclosure may be trained, for example, with at least one strategic framework. Said trained machine learning model may be further configured to generate the graph according to at least one second strategic framework. A strategic framework, for example “Playing to win”, may be a structured approach which may comprise any of an organization's vision, mission, core values, strategic objectives, and the processes or methodologies to achieve these objectives. Such a framework may provide a clear roadmap for decision-making, prioritization, and resource allocation to align efforts across the organization. Examples of such frameworks include Balanced Scorecard, Blue Ocean Strategy, 7S Framework, Playing to Win, etc.

The trained machine learning model of this disclosure may be configured to translate terms, concepts and entire strategies from one strategic framework to another strategic framework. In other words, if a document uses Blue Ocean Strategy terms, the trained machine learning model may be configured to translate the document into 7S Framework terms, for example. An intermediate generalization step may be used in the translation. The ontology used in the training of the model may assist the model in determining similarities between frameworks. Training of the model may be done using pairs of strategy documents with equivalent content but which use different frameworks. For example, 100 such pairs may be used in training.

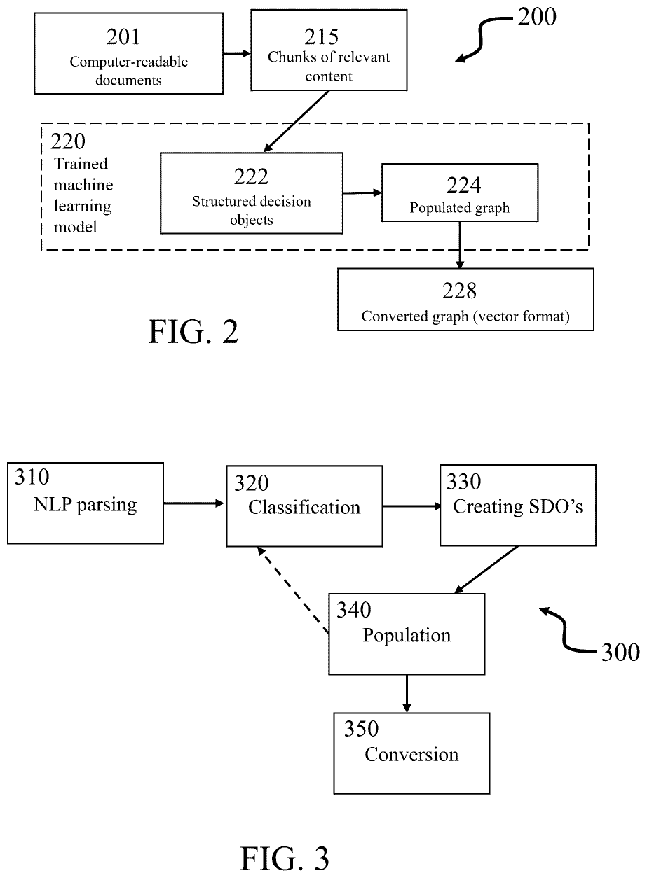

FIG. 2 illustrates an exemplary process 200 in accordance with at least some embodiments of the present disclosure. Process may be performed at least in part by system 100, for example.

In process 200, computer-readable documents 201 are processed, whereby chunks of relevant content 215 are produced. The processing may be done by natural language parser 110, for example. The chunks 215 are provided to a trained machine learning model 220, which may be similar to model 120. Within the model, the chunks 215 are used at least in part to generate structured decision objects 222. At least some of objects 222 are then used to populate a graph 224. The model 220 then outputs the graph 228 in vector format. Graph 228 may be stored in a structured database, for example in database 130.

A user may interact with vector format graph 128, 228 via means for communication 140. The user can, for example, view graph 128, 228 in a browser window. The user can, for example, ask natural language questions of the graph 128, 228 via means for communication 140. A question may be, for example, “What are my business unit's key objectives for the next quarter?”

A user may also search the structured database 130 and thereby the graph 128, 228. The search may be performed by the means for communication 140, which may be configured to vector search, for example nearest neighbor search, the content of the structured database 130.

FIG. 3 illustrates an exemplary process 300 in accordance with at least some embodiments of the present disclosure. Process may be performed at least in part by system 100, for example. Process 300 may be usable with process 200, as process 300 describes phases of a process and process 200 describes the products of the process.

Process 300 comprises a natural language parsing phase 310. The parsing of phase 310, which may be performed by a natural language parser, refers to recognizing relevant content in the entity being parsed, and then extracting the recognized relevant content. Typically, unstructured documents are parsed in phase 310. As a result of the parsing, extracted chunks of content may be provided to at least one other phase, in particular phase 320.

Phases 320, 330 and 340 of the process 300 are interlinked, as they may be performed by a trained machine learning model in rapid succession. Said phases may be performed in an overlapping manner. Said phases may be performed iteratively, for example the result of phase 340 may be provided to phase 320 and/or 330. For example, after the graph is populated in phase 340, additional objects may be created by phase 330. The phases 320, 330 and 340 may be termed “codification”.

Process 300 comprises a classification phase 320. Classification, which may be performed by a trained machine learning model, comprises processing input data and assigning it to one or more categories. In phase 320, the input data comprises extracted chunks of content of phase 310, and the categories may be structured objects in accordance with this disclosure. The structured objects may be provided to at least one other phase, in particular phase 330.

Process 300 comprises a structured object generation phase 330. In the phase, a trained machine learning model may generate at least one structured object. A structured object may be a structured decision object or a structured execution object. A structured object may be used as a node in a generated graph, for example as a node in a semantic network. Structured objects may have inputs and/or outputs, whereby such inputs and/or outputs may be used by the trained machine learning model to generate a graph.

Process 300 comprises a graph population phase 340. In this phase, the trained machine learning model is configured to create edges and weights between structured objects.

Process 300 comprises a conversion phase 350. In the phase, the generated graph is converted, for example by the trained machine learning model, into vector format.

Process 300 may optionally comprise a further phase, where the converted graph is stored in a structured database.

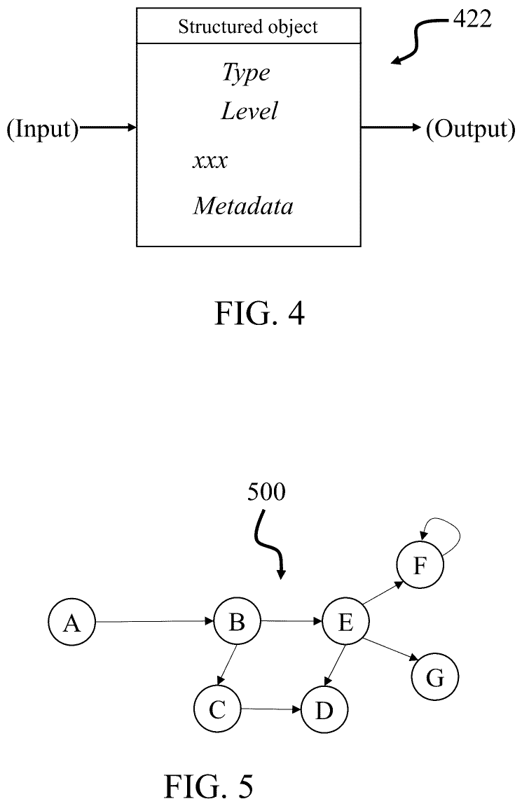

FIG. 4 illustrates an exemplary decision object 422 in accordance with at least some embodiments of the present disclosure. Such a decision object may be any of: a structured execution object, a structured decision object, a structured capability object. This may be termed the “type” of the object.

The structured object 422 may have at least one input. An input can be thought of “what's needed” to achieve a goal or objective of the structured object. An input may be the output of a structured object, for example another structured object. A structured object may be its own input (recursion). A structured object may have several inputs, for example it may have inputs from several other structured objects (N to 1). For example, if the structured object is “Improve advertising conversion rate”, it may be linked to, for example depend on another object called “Increase sales”. Thus, the “Improve advertising conversion rate” is what's needed to “increase sales”.

The structured object 422 may have at least one output. An output can be thought of something that “helps achieve” to achieve a goal or objective of another structured object. An output may be an output to a structured object, for example another structured object. A structured object may be its own output (recursion). A structured object may have several outputs, for example it may output to several other structured objects (1 to N). For example, if the structured object is “Increase North America market share”, it may output to another object called “Increase Mexico market share”. Thus, the “Increase North America market share” is helped to be achieved by “Increase Mexico market share”.

The structured object 422 is of a type. For example, a structured decision object may be at least one of: a choice, a decision, a goal, a KPI.

The structured object 422 has a level. The level may correspond to a hierarchy within the ontology. For example, the ontology may comprise a hierarchy of decisions, wherein the hierarchy comprises a plurality of decision categories, for example major decisions, minor decisions, and detail-level decisions. Thus, the object level may be major, minor, detail-level, and/or task level.

The structured object 422 may comprise information. The information may comprise or be based on at least one chunk of relevant content extracted from a computer-readable document. The information may comprise further information inserted in the object by a trained machine learning model.

The structured object 422 may comprise metadata. Metadata may comprise at least one of: the owner of the object, a priority (importance) of the object, a due date for the project.

FIG. 5 illustrates an exemplary graph 500 in accordance with at least some embodiments of the present disclosure. The graph may comprise structured objects, for example structured decision objects. Said objects may be nodes of the graph. Said objects may be recursive. The graph may be formed by the trained machine learning model, for example the trained machine learning model is configured to create edges and weights between structured objects. The creation may be based at least in part on data provided to the natural language parser and/or the trained neural network model, for example on chunks of relevant content. The graph may be a semantic network. The graph may be a complex graph, owing to the recursive and multiple dependency properties of the graph.

Within graph 500, it can be seen that node B depends on node A. In other words, the input or output of B is connected to the input or output of A, for example the output of A is connected to the input of B. Nodes E and C depend on node B. Node D depends on both node C and node E. Nodes F, G, and D all depend on node E. Node F depends on itself and node E.

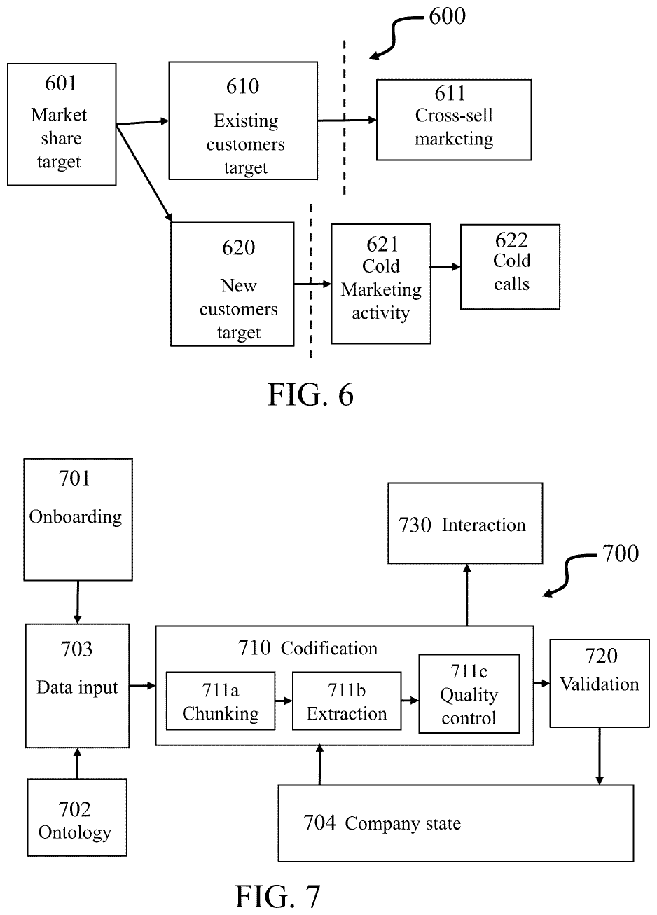

FIG. 6 illustrates an exemplary hierarchy 600 of structured objects in accordance with at least some embodiments of the present disclosure. Hierarchy 600 is an example of a graph generated by a trained machine learning model. The visual representation in FIG. 6 is to assist in understanding the hierarchy. The hierarchy 600 may be stored in vector format. The dotted lines within FIG. 6 illustrate the border between decision objects and execution objects, wherein the left side of the lines are decision objects and the right side of the lines are execution objects.

Hierarchy 600 comprises objects 601, 610, 611 and objects 620, 621, 622. Structured decision object 601 is a major-level decision. The trained machine learning model may have created the object 601 based on a chunk of relevant content such as a statement within a strategy document emphasizing the need for new business markets.

Structured decision object 610 is a minor-level decision. The trained machine learning model may have created the object 610 based on a detected and/or determined need to fulfil the objective of object 601. In other words, trained machine learning model may use the ontology and its training to determine that increasing market share usually requires more business from existing customers.

Structured object 611 is a structured execution object. The trained machine learning model may have created the object 611 based on a detected and/or determined need to fulfil the objective of object 610. In other words, trained machine learning model may use the ontology and its training to determine that increasing business from existing customers may be done best by cross-selling new services to said customers. The trained machine learning model may suggest several possibilities to fulfil a higher-level objective, whereby a user may select a suitable approach and/or the trained machine learning model may select it autonomously. Further, the user may discuss the approach with the trained machine learning model. Structured object 611 comprises a capability requirement, for example there may be a marketing resource requirement listed within object 611 in order to achieve the higher-level objective.

Structured decision object 620 is a minor-level decision. The trained machine learning model may have created the object 620 based on a detected and/or determined need to fulfil the objective of object 601. In other words, the trained machine learning model may use the ontology and its training to determine that increasing market share usually requires business from new customers. The trained machine learning model may use the ontology, as well as the training material, to provide complementary and/or exclusive further approaches to objectives generated based on chunk(s) of relevant content.

Structured object 621 is a structured execution object (detail level). The trained machine learning model may have created the object 621 based on a detected and/or determined need to fulfil the objective of object 620. In other words, trained machine learning model may use the ontology and its training to determine that increasing business from new customers may be done best by cold marketing activity. Structured object 621 comprises a capability requirement.

Structured object 622 is a structured execution object (task level). The trained machine learning model may have created the object 622 based on a detected and/or determined need to fulfil the objective of object 621. In other words, trained machine learning model may use the ontology and its training to determine that cold marketing activity is best done by cold calls. The trained machine learning model may determine a required key result (target result) for object 622 based on any of the chunks of relevant content and/or the content of any other objects (nodes) within the graph. Structured object 621 comprises a capability requirement.

FIG. 7 illustrates an exemplary process diagram 700 in accordance with at least some embodiments of the present disclosure. Process 700 may be performed at least in part by system 100, for example. Process 700 may be usable with process 200, as process 700 describes phases of a process and process 200 describes the products of the process.

Initial phase 701 comprises an onboarding phase. In this phase, company information, for example one or more of: organization structure, organization functions, time frames, vision, mission, financial information and/or any further company information is collected, for example via a UI performed by a web browser.

In phase 702, which may be performed concurrently with phases 701, 702, an ontology is provided to the system. The ontology may be stored on an electronic storage medium, for example accessible to the UI performed in the web browser or to backend functions. The ontology may comprise any of: rules and categories, a priori information of typical relationships between entities, frameworks, a hierarchy of decisions, wherein the hierarchy comprises a plurality of decision categories, for example major decisions, minor decisions, and detail-level decisions.

In phase 703, the collected data from the onboarding phase and the ontology phase is provided to a trained machine learning model. Further, content from the internet may be provided to the trained machine learning model. Further, strategy documents and/or leadership team documents may be provided to the trained machine learning model. The provided data may be computer-readable documents, for example unstructured documents.

In phase 710, chunks of relevant content are extracted from the provided data. The extraction may be performed by a natural language parser. The extraction may comprise recognizing, in sub-phase 711a, relevant content in the entity being parsed. Then, in sub-phase 711b, the recognized relevant chunks of content are extracted, for example saved on an electronic storage media. In sub-phase 711c, quality control is performed on the extracted data. Quality control may comprise verifying, by the trained machine learning model, the generated entities against company information. During phase 710, the trained machine learning model generates the graph and the objects therein.

In phase 720, validation is performed on the generated entities. Validation may comprise requesting human input on created entities, for example. For example, the user may be asked via the web browser UI if a decision object has been assigned a correct level. During validation, a change log is generated for each change to the generated graph.

In phase 730, the generated graph may be interacted with by at least one user. The user may interact with the generated graph in for example vector format using for example the web browser UI. The trained machine learning model may also interact with the generated graph, for example the trained model may generate predictions, monitor alignment, generate reports, and generate further objects. A change log is generated for each change to the generated graph, and changes of a predetermined magnitude may be subject to superuser approval.

In embodiments, a system in accordance with the present disclosure, for example system 100, 950, may comprise at least one alignment state agent. Such an agent may correspond to a structured object, for example a structured decision object, within the graph. An alignment state agent may be performed by an apparatus comprising at least one processor and memory comprising computer program instructions. A trained machine learning model may be configured to act as an agent for at least one structured decision object, wherein the agent may be configured, for example, to check the dependencies of said single structured decision object.

An agent may be configured to check if there are any concerns with the graph, and/or with the underlying plan. The checks may be run continuously, especially upon events, such as: once per time interval, for example every hour, whenever new data comes through, when an object is edited, when an object is published, for example as part of a review process, when new ingested information is obtained, when input surveys are updated.

An alignment agent may be configured to check if the analysis yields findings (part of the alert). In other words, the alignment agent is configured to perform a check. Checks may range from easy to difficult, deterministic to stochastic as well causal checks. Agents may perform math functions as part of checks.

A check may return a positive result. In such a case the agent may change the state of the structured decision object appropriately, for example “at risk”, or “better plan”. The alignment agent may be configured to measure the state, not the confidence as a percentage, of an object. Thus, the state change is only a state change without changing the underlying assumptions.

An alignment agent may be configured to notify the object owner by providing an alert. This may be done, for example, via other alignment agents. Thus, alerts may cascade to other linked objects, depending for example on the severity of the alerts.

Any analysis findings may be cleared by a user confirming, via UI, that the finding is not a problem, whereby the state of the object is changed to “aligned”. Any analysis findings may be cleared by a review and edit process which changes the state back to “aligned”.

For every object, multiple findings may exist simultaneously. Such findings may be presented as a list, for example within the alert. Such findings may be clearable by the object owner.

Table 1 presents a list of possible agents of the “completeness” type. Multiple agents, including multiple types of agent, may be present in a system.

TABLE 1
Alignment state agents (completeness)

| Agent | Description | Check | Findings |
|---|---|---|---|
| Commitment | Assesses team | Does the object have | <ObjectName> is |
| | commitment levels to | an owner that is | missing an owner. Do |
| | strategic objectives. | committed? | you want to add an |
| | | | owner? |
| Dependencies | Assess if there are | Does the object have | <ObjectName> is |
| form | logical dependencies | correct logical | missing |
| | missing | dependencies? | <DependencyType>. |
| | | For example, a goal | Do you want to add |
| | | should have at least | one? |
| | | one initiative, an | |
| | | initiative should have | |
| | | at least one | |
| | | capabilities. | |
| Dependencies | Tracks and evaluates | Does the objects (e.g. | Your dependency |
| Alignment | dependencies between | ObjectName2) that | <ObjectName> is no |
| | strategic initiatives. | this object | longer aligned. Is this |
| | | <ObjectName1> is | a risk for |
| | | depending on | <ObjectName1>? |
| | | (downstream), have an | |
| | | “alignment”? | |
| Evaluate | Measures | Check if object | <ObjectName> is |
| Form | comprehensiveness of | description conforms | missing some content |
| | strategy/object details | to the object-type | not included currently |
| | for | specific template (for | |
| | execution readiness. | example, .md) | |
| | LLM-based | configured to the | |
| | (stochastic) | system. | |
| | analysis between | This means that | |
| | template and content. | e.g. an initiative is | |
| | | supposed to contain | |
| | | certain descriptions, | |
| | | e.g. an outline for | |
| | | what is being done. A | |
| | | strategic intent is | |
| | | supposed to cover | |
| | | rationale for why this | |
| | | is important, etc. | |

Table 2 presents a list of further possible agents of the “internal event” type. Multiple agents, including multiple types of agent, may be present in a system.

TABLE 2
Alignment state agents (Internal event)

| Agent | Description | Check | Findings |
|---|---|---|---|
| One-hour | Facilitates rapid, | conforms to the object-type | <ObjectName> is |
| strategy | high-level | specific template (.md) | missing a <some |
| | strategy reviews. | configured to the system. For | content not |
| | | example, a strategic intent is | included |
| | | supposed to contain certain | currently> |
| | | descriptions, e.g. an outline for | |
| | | what is being done. A strategic | |
| | | intent is supposed to cover | |
| | | rationale for why this is | |
| | | important, etc. | |
| Execution | Integrates with | Evaluates if a related set of | <ObjectName> |
| Progress | project/OKR tools | tasks is progressing as per | execution in |
| | for tracking and | schedule. | <Platform> is |
| | analyzing | | falling behind |
| | strategic progress. | | schedule. Is this a |
| | | | risk? |

In embodiments, a system in accordance with the present disclosure, for example system 100, 950, may be configured to perform a simulation. A simulation may comprise setting an outcome for at least one structured object and then generating, using the trained machine learning model, a graph based on the outcome. An outcome may be set by the user or by the trained machine learning model. For example, if at least one structured object is “Increase market share” and a negative outcome is set, a failure graph may be generated. Several simulations may be performed based on a single graph, or even a single alteration. A new graph may be generated, using the trained machine learning model, and converted based on a simulation.

In embodiments, a system in accordance with the present disclosure, for example system 100, 950, may be configured to perform a prediction. A prediction may comprise determining, by the at least one trained machine learning model, a likely outcome for at least one of the structured objects, or for example even all of the structured objects. For example, if a negative outcome is predicted for 100% of the objects, a worst-case graph may be generated. Several predictions may be performed based on a single graph, or even a single determined outcome. A new graph may be generated, using the trained machine learning model, and converted based on a prediction.

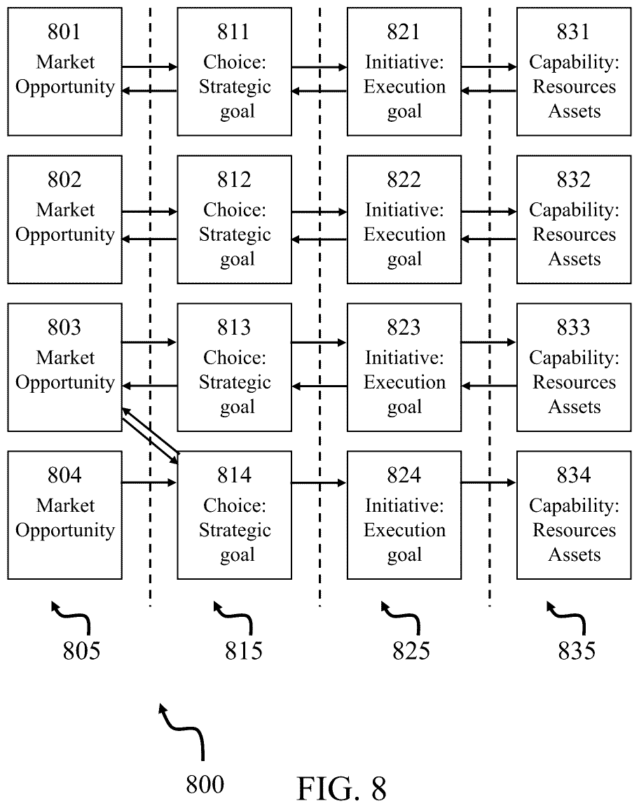

FIG. 8 illustrates an exemplary hierarchy of structured objects in accordance with at least some embodiments of the present disclosure. Hierarchy 800 comprises levels 805, 815, 825 and 835. Each level may comprise structured objects, for example at least one structured object, or zero objects, and/or a plurality of structured objects. The structured objects may be objects in accordance with this disclosure, for example structured decision objects and/or structured execution objects. The structured decision objects may be major-level or minor level, and the structured execution objects may be task-level or detail-level. For example, level 805 may be major level, level 815 may be minor level, level 825 may be task level (also known as initiative level), and level 835 may be a capability level. Thus, the hierarchy 800 corresponds to hierarchy 600, except that hierarchy 800 comprises a capability level.

Level 805 comprises structured decision objects 801, 802, 803, 804. These are termed “market opportunities”. Such opportunities are possible opportunities for the organization. A market opportunity may comprise at least one of: risks, assumptions, competitors. For example, a market opportunity could be the North American microprocessor market, wherein a risk would be foreign lower-cost production, an assumption would be upcoming tariffs, and a competitor would be American Microprocessor Corporation with 5% market share (rising). The market opportunities and the content therein may be presented in the computer-readable documents explicitly or implicitly, wholly or in part. The market opportunities and the content therein may be generated by the trained machine learning model based at least in part on relevant content extracted from at least one computer readable document. Structured decision objects 801, 802, 803, 804 are presented as examples only. It is clear that level 805 may comprise more or fewer structured objects depending on the organization's situation.

As can be seen from the figure, the objects of level 805 are linked to those of level 815. The arrows leading from the level 805 to 815 may be termed “what is needed for this to happen” and the arrows leading from 815 to 805 may be termed “helps to achieve”. This is applicable to the arrows between the other levels as well. In other words, arrows from 815 to 825 and from 825 to 835 are “what is needed for this to happen”, and the arrows from 835 to 825 and from 825 to 815 are “helps to achieve”. These correspond to the input/output as discussed in this disclosure. It can be seen that objects may be linked to several other objects as demonstrated by objects 803, 804 and 814.

Level 815 comprises structured decision objects 811, 812, 813, 814. These are termed “choices”. Such choices are possible options for the organization to pursue. A choice may comprise a strategic goal. For example, a choice could be to establish production facilities in a certain market. The choice and the content therein may be presented in the computer-readable documents explicitly or implicitly, wholly or in part. The choice and the content therein may be generated by the trained machine learning model based at least in part on relevant content extracted from at least one computer readable document. Structured decision objects 811, 812, 813, 814 are presented as examples only. It is clear that level 815 may comprise more or fewer structured objects depending on the organization and on the other levels.

Level 825 comprises structured execution objects 821, 822, 823, 824. These are termed “initiatives”. Such initiatives are possible projects for the organization. An initiative may comprise an execution goal (i.e. a KPI). For example, an initiative could be to produce at least 1000 microprocessors within the USA per annum. The initiative and the content therein may be presented in the computer-readable documents explicitly or implicitly, wholly or in part. The initiative and the content therein may be generated by the trained machine learning model based at least in part on relevant content extracted from at least one computer readable document. Structured execution objects 821, 822, 823, 824 are presented as examples only. It is clear that level 825 may comprise more or fewer structured objects depending on the organization's situation and on the other levels.

Level 835 comprises structured capability objects 831, 832, 833, 834. These are termed “capabilities”. Such capabilities are possible, or actual, resources of the organization. A capability may comprise at least one of: risks, assumptions, competitors. For example, a capability could be a microprocessor production facility. The capabilities and the content therein may be presented in the computer-readable documents explicitly or implicitly, wholly or in part. The capabilities and the content therein may be generated by the trained machine learning model based at least in part on relevant content extracted from at least one computer readable document. Structured capability objects 831, 832, 833, 834 are presented as examples only. It is clear that level 805 may comprise more or fewer structured objects depending on the organization.

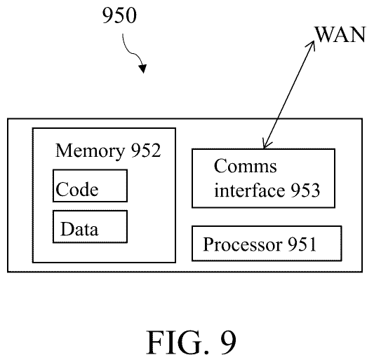

FIG. 9 illustrates a system 950 in accordance with at least some embodiments of the present disclosure. System 950, or at least one memory 952 of system 950, may comprise a trained machine learning model, such as model 120, for example a neural network. System 950 may further optionally comprise or be configured to implement at least one of the following: NLP parser 110, ontology 125, structured database 130, means for communication 140, and/or help monitor 150.

The system 950 comprises at least one processor 951, and at least one memory 952 including computer program code, and optionally data. The system 950 may further comprise a communication unit or interface 953.

Although the system 950 is depicted as including one processor, the system 950 may include more processors. In an embodiment, the memory is capable of storing instructions, such as at least one of: operating system, various applications, models, neural networks and/or, preprocessing sequences. Furthermore, the memory may include a storage that may be used to store, e.g., at least some of the information and data used in the disclosed embodiments.

Furthermore, the processor is capable of executing the stored instructions. In an embodiment, the processor may be embodied as a multi-core processor, a single core processor, or a combination of one or more multi-core processors and one or more single core processors. For example, the processor may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor may be configured to execute hard-coded functionality. In an embodiment, the processor is embodied as an executor of software instructions, wherein the instructions may specifically configure the processor to perform at least one of the models, sequences, algorithms and/or operations described herein when the instructions are executed.

The memory may be embodied as one or more volatile memory devices, one or more non-volatile memory devices, and/or a combination of one or more volatile memory devices and non-volatile memory devices. For example, the memory may be embodied as semiconductor memories (such as mask ROM, PROM (programmable ROM), EPROM (erasable PROM), flash ROM, RAM (random access memory), etc.).

The at least one memory and the computer program code may be configured to, with the at least one processor, cause the system 950 to at least perform as follows: provide, to a natural language parser, at least one computer-readable document; parse, by the natural language parser, said at least one computer-readable document; wherein the parsing extracts at least one chunk of relevant content from the said at least one computer-readable document, provide the extracted at least one chunk of relevant content to a trained neural network model, the trained neural network model being trained on, comprising, and/or having access to a predefined ontology; generate, by the trained neural network model, at least one structured object based at least in part on the extracted at least one chunk of relevant content; generate, by the trained neural network model, a graph model, said graph comprising at least one of the structured objects, wherein the generating comprises: optionally creating, by the trained neural network model, at least one additional structured object, and creating, by the trained neural network model, edges and weights between structured objects; converting the generated graph into vector format; and provide the converted graph in vector format to a structured database.

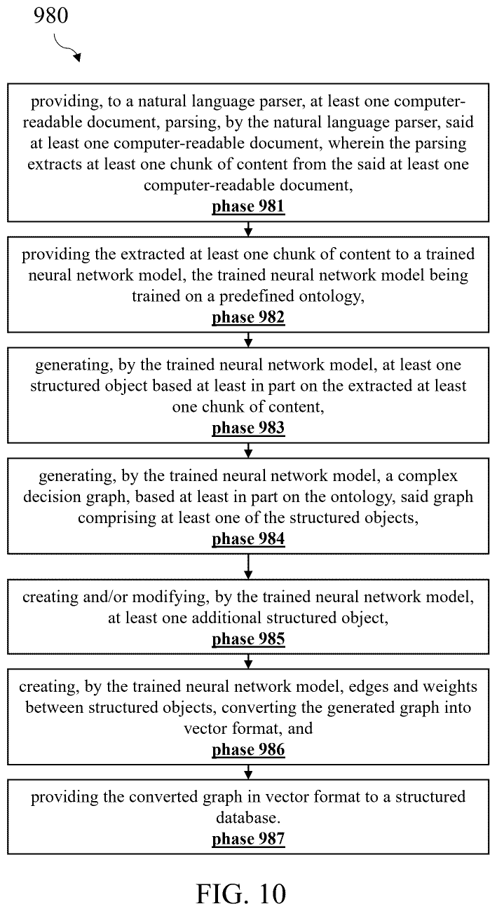

FIG. 10 illustrates a method 980 usable in accordance with at least some embodiments of the present disclosure. Method 980 comprises the following phases: 981, 982, 983, 984, 985, 986 and 987. At least some of said phases may be performed concurrently. Method 980 may be performed by at least system 100, system 950.

Phase 981 comprises providing, to a natural language parser, at least one computer-readable document, parsing, by the natural language parser, said at least one computer-readable document, wherein the parsing extracts at least one chunk of content from the said at least one computer-readable document.

Phase 982 comprises providing the extracted at least one chunk of content to a trained neural network model, the trained neural network model being trained on a predefined ontology.

Phase 983 comprises generating, by the trained neural network model, at least one structured object based at least in part on the extracted at least one chunk of content.

Phase 984 comprises generating, by the trained neural network model, a complex decision graph, based at least in part on the ontology, said graph comprising at least one of the structured objects. The generating may comprise phase 985 and/or phase 986.

Phase 985 comprises creating and/or modifying, by the trained neural network model, at least one additional structured object.

Phase 986 comprises creating, by the trained neural network model, edges and weights between structured objects, converting the generated graph into vector format.

Phase 987 comprises providing the converted graph in vector format to a structured database.

Advantages of the present disclosure include the following: a typical business, business unit or team generates a large amount of computer-readable documents. However, utilizing these documents is difficult as the documents are typically unstructured. Manually structuring the documents, for example according to a predefined ontology, is not viable as the latter parsed documents may affect the context of the earlier parsed documents. Further, any iteration of the process or having multiple contexts per document would be difficult for a human to accomplish.

The embodiments disclosed provide a technical solution to a technical problem. One technical problem being solved is how to generate a structured database, for example a vector database, based on a graph of nodes, said nodes being based on extracted chunks of relevant content from the unstructured documents. Further, the graph may usefully reflect a business plan or strategy.

The embodiments herein overcome these limitations by using computational methods and apparatuses in order to use a specially trained machine learning model to generate the database, which is then provided to a structured database. Other technical improvements may also flow from these embodiments, and other technical problems may be solved.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in populating structured databases based on computer-readable documents.

REFERENCE SIGNS LIST

| | |
|---|---|
| 100 | system |
| 101 | documents |
| 110 | natural language parser |
| 115 | relevant content |
| 120 | machine learning model |
| 125 | ontology |
| 126 | vector format graph |
| 128 | vector format graph |
| 130 | structured database |
| 140 | communication |
| 150 | help monitor |
| 170 | ERP system |
| 200 | process |
| 201 | computer - readable documents |
| 215 | chunks |
| 220 | trained machine learning model |
| 222 | objects |
| 224 | graph |
| 228 | vector format graph |
| 300 | process |
| 310, 320, 330, 340, 350 | phase |
| 422 | structured object |
| 500 | graph |
| 600 | hierarchy |
| 601 | object |
| 610 | object |
| 611 | object |
| 620 | object |
| 621 | object |
| 622 | object |
| 700 | process |
| 701, 702, 703, 710, 720, | phases |
| 730 | |
| 711a, 711b, 711c | sub - phase |
| 800 | hierarchy |
| 801, 802, 803, 804 | structured decision objects |
| 805, 815, 825, 835 | level |
| 811, 812, 813, 814 | structured decision objects |
| 821, 822, 823, 824 | structured execution objects |
| 831, 832, 833, 834 | structured capability objects |
| 950 | system |
| 951 | processor |
| 952 | memory |
| 953 | interface |
| 980 | method |
| 981, 982, 983, 984, 985, | Method phases |
| 986, 987 | |

1-111. (canceled)

112. A method of populating a structured database, the method comprising providing, to a natural language parser, at least one computer-readable document,
parsing, by the natural language parser, said at least one computer-readable document, wherein the parsing extracts at least one chunk of content from the said at least one computer-readable document,
providing the extracted at least one chunk of content to a trained neural network model,
the trained neural network model being trained on a predefined ontology,
generating, by the trained neural network model, at least one structured object based at least in part on the extracted at least one chunk of content,
generating, by the trained neural network model, a complex decision graph, based at least in part on the ontology,
said graph comprising at least one of the structured objects, wherein the generating comprises:
creating and/or modifying, by the trained neural network model, at least one additional structured object, and
creating, by the trained neural network model, edges and weights between structured objects,
converting the generated graph into vector format, and
providing the converted graph in vector format to a structured database.

113. The method of claim 112, wherein the structured objects comprise at least one of: a structured decision object, a structured execution object or a structured capability object.

114. The method of claim 112, wherein the trained neural network model is configured to create additional structured objects and the edges and weights thereof, based at least in part on the extracted at least one chunk of content and at least in part on the graph structure.

115. The method of claim 112, wherein the converted graph in vector format is made accessible, by a user interface device, to a user.

116. The method of claim 115, comprising displaying, by the user interface device, a portion of the converted graph within the structured database.

117. The method of claim 112, wherein the at least one chunk of content is a relevant chunk of content identified by the natural language parser.

118. The method of claim 112, wherein the trained neural network model is configured to translate content from one strategic framework to another strategic framework.

119. The method of claim 112, wherein the structured database is configured to be searchable by a user, wherein the search is performed by a user interface device configured to vector search the structured database.

120. The method of claim 112, wherein the method comprises receiving, in a user interface device, a search query and/or a context search relating to the structured database via a user interface;
generating, by the user interface device, a response based on the search query and/or the context search and the structured database; and
transmitting, by the user interface device, the response via the user interface.

121. The method of claim 112, comprising displaying, by a user interface device, the converted graph within the structured database or a portion thereof at a certain point of time, wherein the user may adjust the displayed point of time.

122. The method of claim 112, comprising accessing and traversing the graph within the structured database by the trained neural network model responsive to user input.

123. The method of claim 112, wherein at least one alignment state agent corresponding to a structured object within the graph is configured to act as an agent for at least one structured decision object, wherein the agent is configured to check the dependencies of said single structured decision object.

124. The method of claim 112, wherein the method comprises performing a simulation, said performing comprising setting an outcome for at least one structured object and generating, using the trained neural network model, a graph based on the set outcome.

125. The method of claim 112, wherein the method comprises performing a prediction, said performing comprising determining a likely outcome for at least one structured object and then generating, using the trained neural network model, a graph based on the likely outcome.

126. The method of claim 112, the method comprising maintaining, in at least one memory accessible to the trained neural network model, the predefined ontology and accessing and/or updating said predefined ontology based on the generated graph.

127. A system for populating a structured database, the system comprising an apparatus comprising a processing core, at least one memory including computer program code, the at least one memory and the computer program code being configured to, with the at least one processing core, cause the apparatus at least to:
receive at least one chunk of content based on at least one computer-readable document, provide the received at least one chunk of content to a trained neural network model, the trained neural network model being trained on a predefined ontology,
generate, using the trained neural network model, at least one structured object based at least in part on the extracted at least one chunk of content,
generate, by the trained neural network model, a graph, said graph comprising at least one of the structured objects, wherein the generating comprises:
creating and/or modifying, by the trained neural network model, at least one additional structured object, and
creating, by the trained neural network model, edges and weights between structured objects,
convert the generated graph into vector format, and
provide the converted graph in vector format to a structured database.

128. The apparatus of claim 127, wherein the structured database is configured to be searched, wherein the search is performed by a user interface device configured to vector search, the structured database.

129. The apparatus of claim 127, wherein the at least one chunk of content is a relevant chunk of content identified by a natural language parser.

130. The apparatus of claim 127, wherein the trained neural network model is trained with market data from a plurality of companies, the market data comprising at least one of:
earnings call data, publicly available data, stock market data;
and where the market data is provided over a time span, and wherein the market data is provided at a frequency from a month to a year.

131. A non-transitory computer readable medium having stored thereon a set of computer readable instructions that, when executed by at least one processor, cause an apparatus to:
receive at least one chunk of content based on at least one computer-readable document,
provide the extracted at least one chunk of content to a trained neural network model, the trained neural network model being trained on a predefined ontology,
generate, using the trained neural network model, at least one structured object based at least in part on the at least one chunk of content,
generate, by the trained neural network model, a graph, said graph comprising at least one of the structured objects, wherein the generating comprises:
creating and/or modifying, by the trained neural network model, at least one additional structured object, and
creating, by the trained neural network model, edges and weights between structured objects,
convert the generated graph into vector format, and
provide the converted graph in vector format to a structured database.
